(19) United States
(12) Patent Application Publication
(10) Pub. No.: US 2018/0307212 A1
(43) Pub. Date: Oct. 25, 2018

(54) SYSTEM AND METHOD FOR THE MAINTENANCE OF AN INDUSTRIAL PLANT

(71) Applicant: SIEMENS AKTIENGESELLSCHAFT, MÜNCHEN (DE)

(72) Inventors: MARTIN SCHNEIDER, MÜNCHEN (DE); SONJA ZILLNER, MÜNCHEN (DE)

(21) Appl. No.: 15/770,768

(22) PCT Filed: Aug. 31, 2016
(86) PCT No.: PCT/EP2016/070540

§ 371 Date: Apr. 25, 2018

(30) Foreign Application Priority Data
Oct. 30, 2015 (DE) 10 2015 221 313.7

(51) Int. Cl. G05B 19/418; G06N 5/02

(52) U.S. Cl. CPC G05B 19/418; G06N 5/022

(57) ABSTRACT

Provided is a system for the maintenance of a plant with at least one input unit for inputting semantically annotated observations of a user with respect to at least one system component of the plant; and a data processing unit for determining maintenance procedures for the maintenance of the plant on the basis of a semantic plant data model of the plant and on the basis of relationship data models, which indicate relationships between plant component states and observations, as a function of the semantically annotated observations inputted by means of the input unit.

### CROSS-REFERENCE TO RELATED APPLICATIONS

This application claims priority to PCT Application No. PCT/EP2016/070540, having a filing date of Aug. 31, 2016, based on German Application No. 10 2015 221 313.7, having a filing date of Oct. 30, 2015, the entire contents both of which are hereby incorporated by reference.

### FIELD OF TECHNOLOGY

The following relates to a system and a method for the maintenance of a plant, in particular an industrial plant.

### BACKGROUND

Plants, in particular industrial plants, are complex and may comprise a multiplicity of different plant components. These plant components comprise both hardware components and software components. Suitable maintenance of the plant is of great importance, since it ensures the productivity of the plant and increases the quality of the products produced. A maintenance management system serves the purpose of ensuring the reliability of the overall plant or individual plant components with respect to performing their function. Any activity that is performed to enable the plant or the respective plant component of the plant to perform its prescribed function can be regarded as maintenance.

In the case of conventional plants, in particular industrial plants, there is only extremely rudimentary integration of the production and maintenance processes and the available technical knowledge. In the case of conventional plants in which the plant components or machines are not operated in a fully automated manner, most employees working on the site of the production plant undertake the maintenance tasks during their daily work. With increasing automation, electrification and digitalization of plants or plant components, monitoring and maintenance applications are increasingly being used. These conventional maintenance applications are however mostly designed for the monitoring of individual or isolated plant components within the plant. The maintenance applications partly comprise predictive or anticipatory maintenance applications, which are intended for the monitoring of individual plant components of the plant. These predictive maintenance applications usually go hand in hand with strategies for preventive maintenance measures, in the case of which the plant components of the plant are shut down at predetermined, usually periodic, time intervals in order to be inspected. On the basis of the result of the inspection, repair measures are then performed and the plant components are subsequently put back into operation or plant components concerned are replaced. On account of the complexity of the underlying processes and operating steps, the situation that usually arises is therefore that those employees or workers who have most experience in dealing with the machines or plant components are no longer concerned with the maintenance processes.

Although in plants there are various stages of maintenance applications and maintenance measures, the following disadvantages consequently exist. The knowledge and expertise of the employees or workers engaged in the production operation are not integrated or used in an efficient way in the maintenance process. The many different monitoring applications used, such as for example predictive maintenance applications, provide important insights with respect to various plant components, but not an overall picture with respect to the performance or capability of the plant. The conventional maintenance measures are consequently focused on local aspects and ignore the functioning or capability of the plant as a whole. Furthermore, in the case of conventional maintenance measures, the semantic knowledge of the structure and the basic functioning of the plant are not taken into consideration in the maintenance process. In particular, the semantic information with respect to the working of the plant components and with respect to their structural connection to one another is not used to interpret the locally performed monitoring observations for the overall plant.

### SUMMARY

An aspect relates to a method and a system for the maintenance of a plant with which the productivity and/or safety of the overall plant is increased.

The embodiment accordingly provides a system for the maintenance of a plant having: at least one input unit for inputting semantically annotated observations of a user with respect to at least one plant component of the plant and having a data processing unit for determining maintenance measures for the maintenance of the plant on the basis of a semantic plant data model of the plant and on the basis of relationship data models, which indicate relationships between plant component states and observations, in dependence on the semantically annotated observations input by way of the input unit.

In the case of one possible embodiment of the system according to embodiments of the invention, at least one monitoring unit for generating machine observations of plant components of the plant is provided and the data processing unit determines the maintenance measures for the maintenance of the plant in dependence on the machine observations generated by the monitoring unit and the semantically annotated observations input by way of the input unit.

In the case of one possible embodiment of the system according to embodiments of the invention, an annotating unit is provided, which automatically semantically annotates the machine observations provided by the at least one monitoring unit and transmits them to the data processing unit.

In the case of a further possible embodiment of the system according to embodiments of the invention, the plant data model and the relationship data models are stored as knowledge data models in a knowledge model database, to which the data processing unit for determining the maintenance measures has access.

In the case of a further possible embodiment of the system according to embodiments of the invention, the input unit comprises an input unit that is portable for a user for inputting semantically annotated observations of the user at the location of the respective plant component of the plant.

In the case of a further possible embodiment of the system according to embodiments of the invention, the portable input unit comprises a portable tablet, which displays to the user an input mask for inputting the semantically annotated observations with respect to the respective plant component in a structured form by means of a pen. This pen may preferably be a so-called smart pen.

In the case of a further possible embodiment of the system according to embodiments of the invention, the portable unit comprises portable glasses for observing the respective plant component by the user and also a microphone for inputting the observations of the user with respect to the plant component considered by him, the observations being annotated automatically in dependence on the plant component being considered.

In the case of a further possible embodiment of the system according to embodiments of the invention, the semantic plant data model indicates the structural and/or functional relationships of the plant components within the plant.

In the case of a further possible embodiment of the system according to embodiments of the invention, the relationship data models comprise a fault-anomaly relationship data model, which indicates possible observations with respect to anomalous plant component states of plant components of the plant.

In the case of a further possible embodiment of the system according to embodiments of the invention, the relationship data models comprise an input data model for inputting observations with respect to plant components of the plant in a structured form.

In the case of a further possible embodiment of the system according to embodiments of the invention, the relationship data models comprise an effect classification data model, which indicates the effects of anomalous plant component states of a plant component on other plant components of the plant.

In the case of a further possible embodiment of the system according to embodiments of the invention, the at least one monitoring unit comprises sensors for sensing operating parameters of plant components, the sensors transmitting sensor data as machine observations to the data processing unit.

In the case of a further possible embodiment of the system according to embodiments of the invention, the semantic plant data model indicates the positions of plant components and of monitoring units within the plant.

In the case of a further possible embodiment of the system according to embodiments of the invention, when abnormal machine observations of a plant component of the plant occur, the data processing unit guides a user by a portable input unit to the position of the monitoring unit indicated in the plant data model and/or to the position of the plant component concerned within the plant.

According to a further aspect, embodiments of the invention provides a plant having an integrated system for the maintenance of the plant with the features specified in patent claim 15.

The embodiment accordingly provides a plant having an integrated system for the maintenance of the plant, the system for the maintenance of the plant comprising:

at least one input unit for inputting semantically annotated observations of a user with respect to at least one plant component of the plant and

a data processing unit for determining maintenance measures for the maintenance of the plant on the basis of a semantic plant data model of the plant and on the basis of relationship data models, which indicate relationships between plant component states and observations, in dependence on the semantically annotated observations input by way of the input unit.

In the case of one possible embodiment of the plant according to embodiments of the invention, it is an industrial plant having a multiplicity of plant components.

In the case of a further possible embodiment of the plant according to embodiments of the invention, the plant is a production plant for the production of products.

In the case of a further possible embodiment of the plant according to embodiments of the invention, the plant is an energy generating plant, in particular a gas turbine plant.

In the case of a further possible embodiment of the plant according to embodiments of the invention, the plant is a vehicle, in particular a train.

According to a further aspect, embodiments of the invention also provides a method for maintaining a plant with the features specified in patent claim 17.

The embodiment accordingly provides a method for maintaining a plant having the following steps:

providing a semantic plant data model of the plant and relationship data models, which indicate relationships between plant component states of the plant components of the plant and observations, and

determining maintenance measures for the maintenance of the plant on the basis of the plant data model provided and on the basis of the relationship data models provided in dependence on semantically annotated observations input by a user with respect to at least one plant component of the plant.

### BRIEF DESCRIPTION

Some of the embodiments will be described in detail, with reference to the following figures, wherein like designations denote like members, wherein:

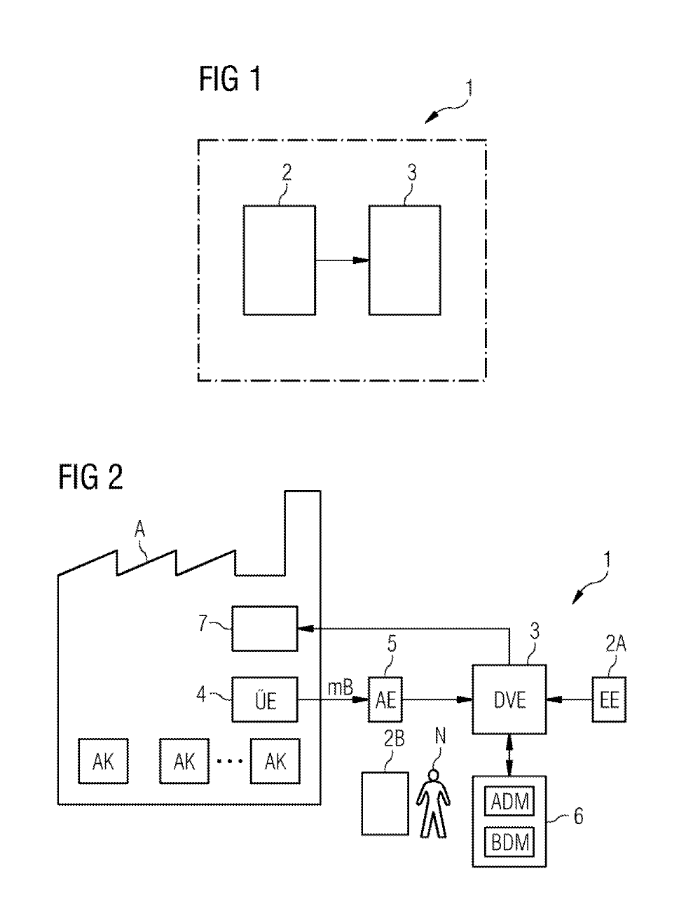

FIG. 1 shows a block diagram of an embodiment of the system for the maintenance of a plant;

FIG. 2 shows a schematic representation of a plant which is maintained by a system for the maintenance of a plant;

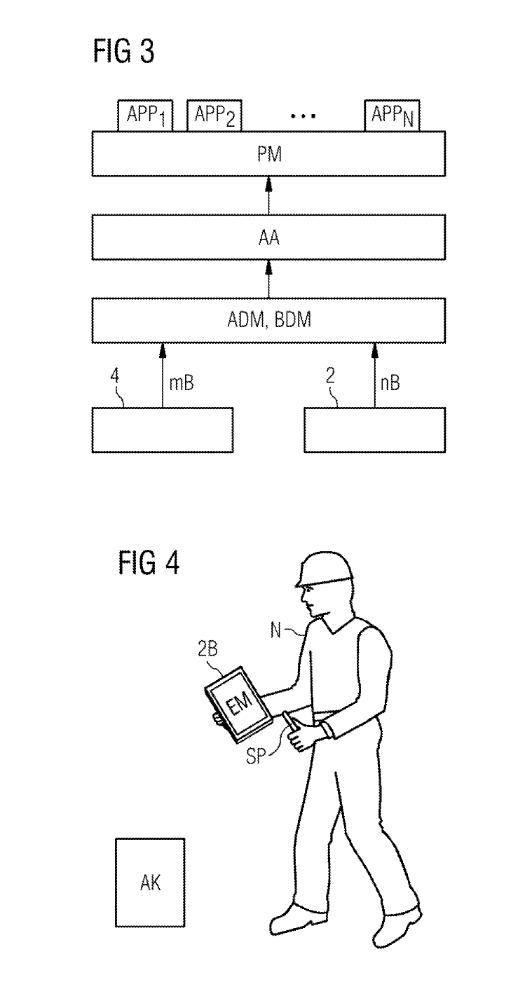

FIG. 3 shows a schematic representation of a possible embodiment of the system for the maintenance of a plant;

FIG. 4 shows a representation of an exemplary embodiment of an input unit used in the case of the system and the method;

FIG. 5 shows an example of an input mask that can be used in the case of the method and the system;

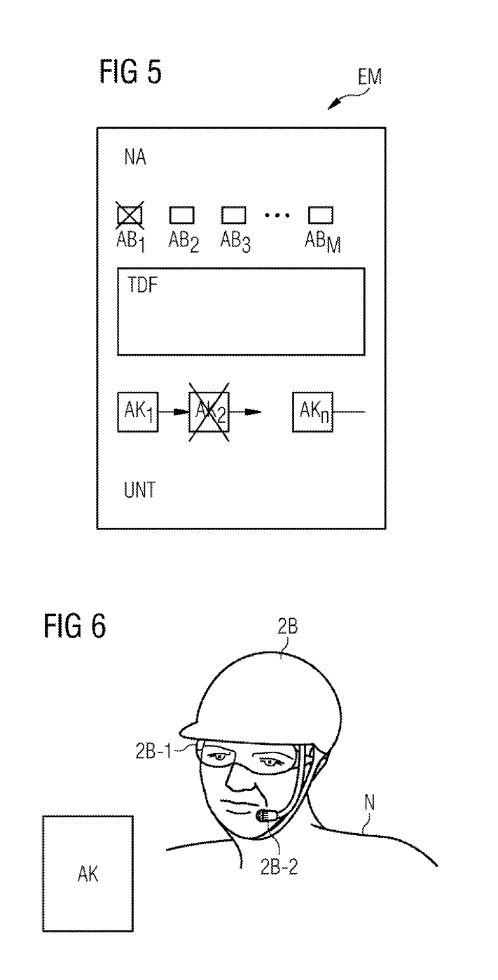

FIG. 6 shows a representation of a further exemplary embodiment of an input unit used in the case of the system and the method;

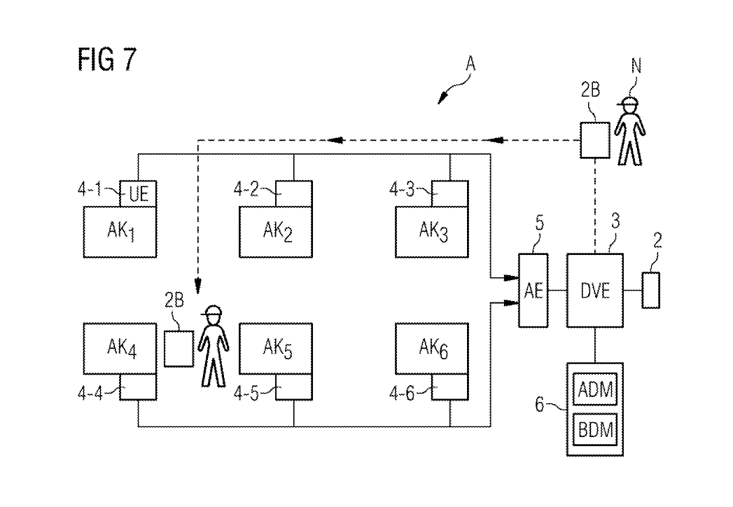

FIG. 7 shows a block diagram for representing an exemplary embodiment of a system for the maintenance of a plant given as an example;

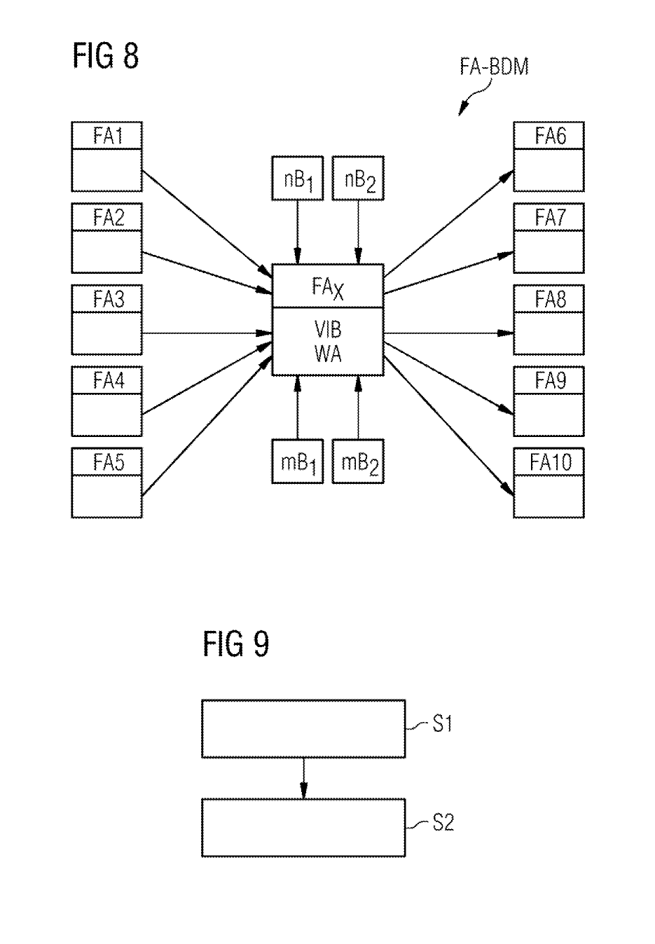

FIG. 8 shows a diagram for representing a relationship data model given by way of example, as can be used in the case of the method and the system for the maintenance of a plant; and

FIG. 9 shows a flow diagram for representing an exemplary embodiment of the method for the maintenance of a plant.

### DETAILED DESCRIPTION

As can be seen from FIG. 1, in the exemplary embodiment represented, a system 1 according to the invention for the maintenance of a plant A comprises substantially two units. In the case of the exemplary embodiment represented in FIG. 1, the system 1 comprises an input unit 2 and a data processing unit 3. The input unit 2 serves for inputting semantically annotated observations of a user, for example a worker, with respect to at least one plant component AK of the plant. The system 1 also comprises a data processing unit 3 for determining maintenance measures for the maintenance of the plant. The data processing unit 3 determines the maintenance measures for the maintenance of the plant A on the basis of a semantic plant data model ADM of the plant and on the basis of relationship data models BDM, which indicate relationships between plant component states AK and observations. In this case, the determination of the maintenance measures by the data processing unit 3 takes place in dependence on the semantically annotated observations input by way of the input unit 2.

FIG. 2 schematically shows a plant A having a multiplicity of different plant components AK. The plant represented in FIG. 2 is, for example, an industrial plant, in particular a production plant for the production of products. Alternatively, the plant A may also be an energy generating plant, for example a gas turbine plant, or a complex vehicle, for example a train. The plant A has a multiplicity of interacting plant components AK. These plant components comprise on the one hand hardware components, for example machines or mechanically controllable parts, and on the other hand software components for controlling the plant components. In the exemplary embodiment represented according to FIG. 2, a monitoring unit 4 is provided for generating machine observations mB with respect to at least one plant component AK of the plant A. In the case of one possible embodiment, the monitoring unit 4 monitors one or more plant components AK by means of sensors. These sensors generate machine observations mB of the various monitored plant components, in particular sensor data, which are transmitted to the monitoring unit 4. In the case of the exemplary embodiment represented in FIG. 2, the monitoring unit 4 transmits the machine observations mB to an annotating unit 5. This annotating unit 5 carries out a semantic annotation of the machine observations mB provided by the monitoring unit 4 and transmits the semantically annotated machine observations to the data processing unit 3 of the maintenance system 1, as represented in FIG. 2. The data processing unit 3 then determines maintenance measures for the maintenance of the plant A in dependence on the machine observations provided by the monitoring unit 4 and the semantically annotated observations nB of a user N input by way of at least one input unit 2. In the case of one possible embodiment, the machine observations, for example sensor data, are transmitted by the monitoring unit 4 directly to the data processing unit 3 for evaluation. In the case of an alternative embodiment, as in the case of the exemplary embodiment represented in FIG. 2, the machine observations or sensor data are first semantically annotated by an annotating unit 5 and then transmitted to the data processing unit 3 for further evaluation. The transmission of the machine observations or sensor data as raw data or in a semantically annotated form preferably takes place in real time. In the case of the exemplary embodiment represented in FIG. 2, the system 1 for the maintenance of the plant A has two input units 2A, 2B. The first input unit 2A is in this case a fixedly installed input unit, for example a keypad, by which input data can be input by a user N into the data processing unit 3. The second input unit 2B is an input unit that is portable for a user N.

As represented in FIG. 2, the data processing unit 3 of the maintenance system 1 has access to a data memory or a knowledge model database 6. Stored in the database 6 are a plant data model ADM of the plant A and also relationship data models BDM as knowledge data models. In the case of one possible embodiment, the data processing unit 3 is an arithmetic and logic unit, which for example comprises one or more microprocessors. The data processing unit 3 determines or calculates maintenance measures for the maintenance of the plant A on the basis of the semantic plant data model ADM of the plant and on the basis of relationship data models BDM, which indicate relationships between plant component states and observations. The determination or calculation of the maintenance measures in this case takes place in dependence on the semantically annotated observations input by way of the input units 2A, 2B. Furthermore, in the case of the exemplary embodiment represented in FIG. 2, the data processing unit 3 may calculate or determine the maintenance measures additionally in dependence on the machine observations mB generated by the monitoring unit 4. For determining the necessary maintenance measures, in the case of one possible embodiment, the data processing unit 3 may give a user N or a member of the maintenance personnel instructions for carrying out the maintenance measures by way of an output interface. In addition, the data processing unit 3 may activate by way of control lines control components 7 within the plant A that assist maintenance personnel in carrying out the maintenance measures. For example, doors within a building of the plant A may be automatically opened in order to provide access for the maintenance personnel or the user N for carrying out the maintenance measures. The input unit 2B represented in FIG. 2 is an input unit that is portable for the user N, for inputting semantically annotated observations of the user N. The user N can, for example, carry the portable input unit 2B directly to the location of the plant component concerned of the plant A and input at the location semantically annotated observations with respect to the state of the respective plant component AK. In the case of one possible embodiment, the observations input by the user N, for example by way of a microphone, are automatically annotated by an annotating unit and transmitted for example by way of a wireless interface to the data processing unit 3 for evaluation. In the case of a further possible embodiment, the portable input unit 2B may for example be formed by a portable tablet, on which an input mask EM is displayed to the user N. This input mask serves for inputting semantically annotated observations nB of the user N with respect to the respective plant components AK in a structured form by means of an input element, for example a pen, in particular by means of a so-called smart pen. In the case of a further possible variant of an embodiment, the portable unit 2B comprises portable glasses for observing the respective plant component AK by the user N and a microphone for inputting the observations nB of the user with respect to the plant component AK being considered by him. In this case, the observations of the user N are preferably semantically annotated automatically by an annotating unit, preferably in dependence on the plant component AK being considered.

The semantic plant data model ADM stored in the database or the data memory unit 6 indicates the structural and/or functional relationships of the various plant components AK within the plant A. In addition to the plant data model ADM of the plant A, one or more relationship data models BDM are stored in the memory unit or the database 6. In the case of one possible embodiment, the stored relationship data models BDM comprise a fault-anomaly relationship data model FABDM, which indicates possible observations with respect to anomalous plant component states of plant components AK of the plant A. The fault-anomaly relationship data model FABDM is a knowledge data model which semantically indicates relationships between plant failures, for example a damaged plant component, and indicates observations that are made with respect to anomalies of the plant or plant components. These anomalies are for example an unusual noise or unexpected data or sensor values. The fault-anomaly relationship data model in this case offers the necessary background knowledge or knowledge of context, in order to automatically classify a set or group of anomaly observations as an abnormal state or failure. The anomaly observations are provided on the one hand as machine observations mB by monitoring units 4 of the plant components or machines and on the other hand as user observations nB of users or of maintenance personnel. The fault-anomaly relationship data model FABDM stored in the database 6 preferably additionally comprises information with respect to the causes of faults and possible effects of such faults or failures. For example, the fault-anomaly relationship data model FABDM may indicate that a first fault F1 is caused by a second fault F2.

In the case of one possible embodiment, the relationship data models BDM stored in the data memory 6 also comprise an input relationship data model EBDM for inputting observations with respect to plant components AK of the plant A in a structured form. Thus, a number of knowledge data models may be provided, allowing data or information to be input or collected in a structured form with respect to possible incidents, observations or anomalies. These input relationship data models EBDM form an interface for the seamless collection of data and in order to bring these data automatically into accord with available plant component state data of the plant A concerned. The input relationship data models EBDM are in this case capable of collecting and preparing both monitoring data generated by machines or monitoring units and data input by users.

In the case of a further possible embodiment of the system according to the invention, the relationship data models BDM stored in the database 6 comprise an effect classification relationship data model AKBDM, which indicates the effects of anomalous plant component states of one plant component AK on another plant component AK of the plant A. The effect classification relationship data model is a knowledge data model that semantically describes which plant components AK of the plant are critical for the safe operation of the plant. The effect classification relationship data model may for example describe possible faults and the associated effects on other plant components. Furthermore, the effect classification relationship data model may indicate the probability of failure events or fault events in the case of various plant components AK of the plant A. The context information represented by the effect classification relationship data model forms the basis for classifying the effect of a possible fault or failure, presupposing that data or information with respect to observations of anomalies or abnormal plant component states are available. The effect classifications thereby yielded may be used for example by other processes, which decide which type of actions or maintenance measures must be initiated.

In the case of the exemplary embodiment of the maintenance system 1 according to the invention that is represented in FIG. 2, the monitoring unit 4 preferably comprises sensors for sensing operating parameters of various plant components AK. In this case, the sensor data may be transmitted to the data processing unit 3 of the maintenance system 1 directly or semantically annotated as machine observations. In the case of one possible embodiment, the sensor data may be evaluated in order to determine critical plant components or plant components with an abnormal state of the plant within the plant A. In the case of one possible embodiment, when abnormal machine observations mB of a plant component AK of the plant A occur, the data processing unit 3 guides a user N by his portable input unit 2B to the position of the associated monitoring unit 4 indicated in the plant data model ADM of the plant A and/or to the position of the abnormal plant component AK concerned. In the case of one possible embodiment, the plant data model ADM indicates the position coordinates of the various plant components AK and the associated monitoring units 4 within the plant. If a plant component AK shows abnormalities, the data processing unit 3 can determine the position of the plant component AK concerned within the plant A on the basis of the plant data model ADM and transmit it to the portable input device of the user N by way of an interface. The user can then be led or guided through the data processing unit 3 with the aid of a navigation system, in order to view personally the plant component AK concerned. As soon as the user has reached the plant component AK concerned within the industrial plant A with the portable input device 2B, he can for his part make observations with respect to the plant component AK, which are transmitted to the data processing unit 3. The data processing unit 3 then has in addition to the machine observations mB also observations nB made by the user N at the location with respect to the plant component AK concerned. If, for example, the plant component AK is a tank that receives a liquid for a production process, a monitoring unit 4, for example a filling level sensor, can establish a drop in the liquid present in the tank and transmit these machine observations mB to the data processing unit 3. As soon as the dropping of the liquid within the tank or the plant component is found by the data processing unit 3 to be below a threshold value, it can lead a user N by a portable input unit 2B to the position of the plant component or the filling tank by navigation instructions. When the user N reaches the filling tank, he can for example observe that a puddle or the like has formed under the filling tank because of a leak. The user N can transmit these observations nB in a semantically annotated form to the data processing unit 3 by way of a wireless interface. The plant component AK generally has a fixed position in the plant A. However, it is also possible that the plant component AK is movable in the plant A, for example a transport vehicle for transporting materials.

FIG. 3 schematically shows a general overview of the units used in the case of the maintenance system 1 according to the invention. The system is based on the one hand on data or observations mB generated by machines and on the other hand on observations nB made by humans or users. On the lowermost level of the system 1 schematically represented in FIG. 3, a data acquisition of the observations is performed. The input units 2, which have in each case an intelligent user interface UI, allow user observations nB to be collected. With the aid of monitoring applications, it is also possible to pass machine observations mB to the data processing unit 3 on the basis of the plant data model ADM, which is located in the database 6. In addition to the machine observations mB, the data processing unit 3 also receives the observations nB originating from at least one user N. In the data processing unit 3, a semantic data integration and the data processing take place on the next level. This takes place on the basis of the stored semantic relationship data models BDM. Building on that, analytical applications AA, which evaluate the semantically integrated data, can be performed by the data processing unit 3. At the next-higher level, process models PM can use the evaluation results of the analysis applications AA. Various applications APP can for their part access the process models PM. The data or observations mB generated by machines may originate from various state-based monitoring applications of data repositories of the plant A. The user observations nB may be supplied by intelligent user interaction applications. For example, a user or technician working in the production area of a plant A can use a smart pen application to report abnormal events or anomalies. These anomalies comprise any kind of deviations, for example an unexpected noise of a plant component AK. The obtainment of the user observations is preferably implemented in such a way that it does not cause the production experts to be obliged to make any unnecessary additional effort or interrupt their working routine. The user observations nB are preferably collected or picked up in a structured semantic form. The respective input areas of an input mask EM are in this case preferably semantically labeled or marked. The instance data obtained are preferably automatically labeled or marked with semantic concepts, so that they can be further processed easily.

In the case of one possible embodiment, the data processing unit 3 uses a plant data model ADM, which comprises all data sources that generate data in the context of the production process of the plant A. For example, historical information about the production process achieved may be collected. The various data sources may in this case be provided throughout the production chain. Provided in the plant A are various monitoring applications, which in the case of one possible embodiment continuously monitor or measure plant component states of various plant components AK in order to establish whether they have already failed or are likely to fail imminently. The collected data allow the state of the plant components AK to be monitored with respect to certain features, for example with the aid of a vibration analysis or infrared-thermographic evaluation or an ultrasound detection. The collected data are preferably recorded. The recorded data can then be used for determining the state of an individual plant component AK or a group of plant components AK in order to decide whether maintenance measures are required. The recorded data with respect to possible anomalies are in this case brought into accord with the associated input relationship data model EBDM, preferably wirelessly, in order to form the basis for the integration of the machine observations or observations nB originating from the user.

FIG. 4 shows an example of a portable input unit 2B used in the case of the maintenance system according to the invention. The user N, for example a worker or member of the maintenance personnel, carries with him a portable tablet 2B, which in the case of one possible embodiment displays to the user N an input mask EM. This input mask EM serves for inputting semantically annotated observations with respect to a plant component AK in a structured form, for example with the aid of a pen, in particular by means of a so-called smart pen SP, as represented in FIG. 4. Instead of an input mask EM, in the case of one possible embodiment the user N can also use a conventional pen to complete a corresponding form, which is subsequently input in a structured form into the system 1 with the aid of an input unit 2A.

FIG. 5 shows an example of an input mask or a corresponding form. A user N can complete the form represented in FIG. 5 or a corresponding input mask EN at the location, i.e. at the location of the plant component AK concerned. For example, the user N can use the input mask EM to enter his name NA. Furthermore, the user N can input the observations nB made by him and, if appropriate, describe them in more detail. In the case of one possible embodiment, the corresponding plant A with its plant components AK is also displayed to the user, so that he can select the plant component AK concerned in the plan presented. In the case of one possible embodiment, the input masks or the form can be signed by the respective user N. The user interface allows the data to be input in a semantically annotated form. This is preferably achieved by establishing the underlying context of the user inputs in the corresponding semantic terminology. In the case of one possible embodiment, a smart pen application with a corresponding input mask or a paper input form is used. In this case, the input mask or the form is preferably individually designed for the plant A to be maintained, as represented by way of example in FIG. 5. In the case of the example represented in FIG. 5, the user N inputs the observations nB made by him, in that for example he selects the plant component AK concerned in the graphic representation of the plant A, as it is presented in the input mask or the form. The selection of the plant component AK concerned takes place for example by the user N touching, crossing or circling the plant component AK in the graphic representation (for example AK2, as represented in FIG. 5). Furthermore, the user N can cross various selection boxes AB. For example, he can select a prescribed anomaly or abnormality, for example noise or odor or the like. In a text data field TDF, the user N can also describe in more detail the anomaly or abnormality selected by him. For example, the user N can state about the anomaly “noise” (selection box AB₁) “very loud, not as normal”. The user can sign the input mask EM or the form with his signature UNT. The input mask represented in FIG. 5 or the input form represented are merely shown by way of example and can be designed differently for different plants A. The input data are preferably evaluated automatically by the data processing unit 3 and, for example, stored in an event report data model.

FIG. 6 shows a further exemplary embodiment of a portable input unit 2B that can be used in the case of the system 1 according to the invention. In the case of the exemplary embodiment represented in FIG. 6, the user N wears a helmet and portable glasses 2B-1 for observing the respective plant component AK. The portable input unit 2B has in addition to the portable glasses 2B-1 a microphone 2B-2 for inputting observations of the user N with respect to the plant component AK being considered by him. In the case of one possible embodiment, these observations nB are automatically annotated by an annotating unit integrated in the portable input unit 2B and subsequently transmitted to the data processing unit 3 of the maintenance system 1 by way of an interface. In the case of one possible embodiment, an input mask or a checklist is displayed to the user N by way of the portable glasses 2B-1. This checklist sequentially displays questions with respect to the plant component AK observed by him, which the user N can answer or comment on with the aid of the microphone 2B-2. In the case of one possible embodiment, the questions in the checklist or the input mask EN that are displayed to the user N by way of the portable glasses 2B-1 are automatically generated by the data processing unit 3 in dependence on the sensor data of an associated monitoring unit provided on the plant component AK and are transmitted to the portable input unit 2B by way of a wireless interface. If the plant component AK is for example a liquid tank, for example an oil tank, and a filling level gage present there as a monitoring unit 4 indicates a dropping of the liquid level below a critical threshold value, the question whether a pool of oil has formed under the oil tank can be displayed to the user N in the depicted input mask EM. The user can subsequently speak his observation nB in this respect into the microphone 2B-2 of the portable input unit 2B. He can for example state whether no pool of oil has formed under the plant component AK or that a pool of oil which is small, medium-sized or very large has formed under the plant component AK.

FIG. 7 schematically shows a further exemplary embodiment of the maintenance system 1 according to the invention. In the case of the exemplary embodiment represented, the plant A has six plant components AK1 to AK6, which are monitored in each case by an associated monitoring unit 4-1 to 4-6. The monitoring units generate machine observations or sensor data of the various plant components AK of the plant. These sensor data or machine observations mB are fed to an annotating unit 5, which performs a semantic annotation of the machine observations and passes it on to the data processing unit 3. In the case of the example represented in FIG. 7, for example, the machine observations of the monitoring unit 4-2 indicate that the plant component AK4 is in a critical state. The data processing unit 3 subsequently guides or directs the user N by his portable input unit 2B to the position of the monitoring unit 4-4 or to the position of the plant component AK4 concerned within the plant, as schematically indicated in FIG. 7. This preferably takes place by evaluation of the associated plant data model ADM of the corresponding plant A. As soon as the user N has reached the plant component AK4 concerned, he can with the aid of the portable input unit 2B subsequently make his personal observations, which are transmitted as user observations nB to the data processing unit 3 for evaluation. In this way, the data processing unit 3 has not only machine observations mB, but also user observations nB of the plant component AK concerned, in order to determine and initiate corresponding maintenance measures.

FIG. 8 schematically shows possible observations B, which can be evaluated by a data processing unit 3. On the one hand, user observations nB can be input and on the other hand machine observations mB can be evaluated. The user observations nB are for example input by means of a structured event report by way of an input unit 2A, 2B of the system 1. One user observation nB₁ states for example that a plant component AK is producing an abnormal noise. A further user observation nB₂ may be that vibrations can be felt through a floor of the plant. One machine observation mB₁ is for example that sensor data of a vibration sensor indicate a deviation from the normal state of the plant component AK A further machine observation mB₂ may be for example that, in the area of product quality assurance, periodic changes in the thickness of a product produced, for example a rolled sheet, are found. The user observations nB and the machine observations mB indicate a fault anomaly FAₓ of a corresponding plant component AK, for example roller WA. In the case of the example represented in FIG. 8, further fault anomalies FA that may lead to the observed “vibration at roller” fault anomaly FAₓ are shown on the left side. Furthermore, fault anomalies FA that may be a consequence of the “vibration at roller” fault anomaly FA that has occurred are shown on the right side. FIG. 8 consequently shows a relationship data model BDM with relationships between various fault anomalies FA of a plant A. Causes of the “vibration at roller” fault anomaly FAₓ that has occurred may be for example the following fault anomalies FA, specifically a defective roller bearing FA1, worn rolling surfaces FA2 and imbalanced driving axles FA3, rolling rotation deviations FA4 or an excessive overall speed of rolling rollers of the plant FA5. All of these fault anomalies FA1 to FA5 may be the cause of the “vibration at roller” fault anomaly FAₓ. On the other hand, the fault anomaly FAₓ that has occurred may for its part have effects on other plant components AK. The vibrations VIB may lead to wearing of the roller bearings FA6 or wearing of the rolling surfaces FA7. Furthermore, the vibrations may be transferred to other plant components AK FA8. Furthermore, the vibrations may have the effect that the rolled-out sheet varies in its thickness FA9. In addition, the vibrations may have the effect that the rolled-out sheet has cracks FA10. FIG. 8 schematically shows a detail of a complex fault-anomaly relationship data model FABDM, which represents a relationship data model stored in the database 6 of the maintenance system 1 according to the invention.

Data analysis applications can access the semantic data models in order to calculate effects on the plant A and its performance. For example, the prediction of an event may describe the time of failure of a machine component X. This failure may for example be classified as particularly critical. By contrast, for example, the prediction of an event within the next few days affecting another machine component Y, which can be easily replaced by a suitable similar component Z, may be classified as less critical.

Process models may indicate a collection of structured activities or tasks that are to be carried out to achieve a certain objective. For example, in the case of a critical event affecting a component X, a safety center may be informed about this and pass on this information together with the event in an aggregated form to a responsible safety official and at the same time automatically pass on a routine for maintenance measures to the service personnel. Furthermore, at the same time a replacement part for the plant component AK concerned may be ordered.

In the case of the maintenance system 1 according to the invention, first all the relevant data sources of the plant data model ADM may be semantically annotated with associated semantic markings or labels in an initialization phase. The plant data model is initialized with associated references, which link the description of the plant data model with the specific storage location of measurements that are generated during the production process and stored in the database. These annotations may be generated automatically or be performed by an expert. The relationship data models BDM, in particular fault-anomaly relationship data models, and the event report data models are likewise initialized in the initialization phase. For example, all the input data flows from plant components AK or monitoring applications and also event reports for anomaly observations are semantically linked and correlated with corresponding fault descriptions. Finally, all the process models are initialized in accord with the production process of the plant A, also taking into consideration the available personnel that can be used for carrying out the various activities.

After initialization of the maintenance system 1 according to the invention, machine observations mB are continuously provided by the monitoring units while the operation of the plant A is in progress. Furthermore, user observations are made available to the data processing unit 3 with the aid of intelligent user interfaces. For the case where critical situations are detected by analysis applications, corresponding actions or activities, in particular maintenance measures, can be automatically initiated or triggered by the maintenance system 1 according to the invention. With the aid of the system 1 according to the invention, a seamless linking of user observations nB and machine observations mB takes place, in order specifically to automatically determine or calculate maintenance measures for increasing the productivity of a plant A.

FIG. 9 shows a flow diagram for representing an exemplary embodiment of the method according to the invention for the maintenance of a plant.

In a first step S1, a semantic plant data model ADM of the plant A and the various relationship data models BDM, which indicate relationships between plant component states of the plant components AK of the plant A concerned and observations B, are provided. Subsequently, in a step S2, maintenance measures for the maintenance of the plant A are determined. This takes place on the basis of the plant model ADM provided and on the basis of the relationship data models BDM provided, in dependence on semantically annotated observations with respect to at least one plant component AK of the plant that are input by at least one user N. The determination of maintenance measures in step S2 preferably takes place by a data processing unit 3 of the system 1. In this case, the maintenance measures are calculated. The determined maintenance measures can be displayed to one or more users N for carrying out the maintenance measures by way of an interface. Furthermore, maintenance measures can also be automatically performed at least partially automatically by corresponding activation of components.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A system for maintenance of a plant comprising:
at least one input unit for inputting semantically annotated observations of a user with respect to at least one plant component of the plant; and
a data processing unit for determining maintenance measures for the maintenance of the plant on a basis of a semantic plant data model of the plant and on a basis of relationship data models, which indicate relationships between plant component states and observations, in dependence on the semantically annotated observations of the user input by way of the at least one input unit.

2. The system as claimed in claim 1, wherein at least one monitoring unit for generating machine observations of the at least one plant components of the plant is provided and the data processing unit determines the maintenance measures for the maintenance of the plant in dependence on the machine observations generated by the at least one monitoring unit and the semantically annotated observations input by way of the at least one input unit.

3. The system as claimed in claim 2, wherein an annotating unit is provided, which automatically semantically annotates the machine observations provided by the at least one monitoring unit and transmits the machine observations to the data processing unit.

4. The system as claimed in claim 1, wherein the semantic plant data model and the relationship data models are stored as knowledge data models in a knowledge model database, to which the data processing unit for determining the maintenance measures has access.

5. The system as claimed in claim 1, wherein the at least one input unit comprises a portable input unit that is portable for the user for inputting semantically annotated observations of the user at a location of the respective plant component of the plant.

6. The system as claimed in claim 5, wherein the portable input unit comprises a portable tablet, which displays to the user an input mask for inputting the semantically annotated observations with respect to the respective plant component in a structured form by means of a a smart pen.

7. The system as claimed in claim 5, wherein the portable unit comprises portable glasses for observing the respective plant component by the user and also a microphone for inputting the semantically annotated observations of the user with respect to the plant component considered by the user, the semantically annotated observations being annotated automatically in dependence on the plant component being considered.

8. The system as claimed in claim 1, wherein the semantic plant data model indicates the structural and/or functional relationships of the plant components within the plant.

9. The system as claimed in claim 1, wherein the relationship data models comprise a fault-anomaly relationship data model, which indicates possible observations with respect to anomalous plant component states of plant components of the plant.

10. The system as claimed in claim 1, wherein the relationship data models comprise an input relationship data model for inputting observations with respect to plant components of the plant in a structured form.

11. The system as claimed in claim 1, wherein the relationship data models comprise an effect classification relationship data model, which indicates the effects of anomalous plant component states of a plant component on other plant components of the plant.

12. The system as claimed in claim 2, wherein the at least one monitoring unit comprises sensors for sensing operating parameters of plant components that transmit sensor data as machine observations to the data processing unit.

13. The system as claimed in claim 1, wherein the semantic plant data model indicates the positions of plant components and of the at least one monitoring units within the plant.

14. The system as claimed in claim 13, wherein, when abnormal machine observations of a plant component of the plant occur, the data processing unit guides the user by a portable input unit to the position of an at least one monitoring unit indicated in the plant data model and/or the position of the plant component concerned within the plant.

15. A plant having an integrated system for maintenance of the plant as claimed in claim 1.

16. The plant as claimed in claim 15, wherein the plant is at least one of an industrial plant, a production plant, an energy generating plant, a gas turbine plant, and/or a vehicle, and/or a train.

17. A method for maintaining a plant comprising:
(a) providing a semantic plant data model of the plant and relationship data models, which indicate relationships between plant component states of the plant components of the plant and observations; and
(b) determining maintenance measures for the maintenance of the plant on a basis of the plant data model provided and on a basis of the relationship data models provided in dependence on semantically annotated observations input by a user with respect to at least one plant component of the plant.
